(19) United States
(12) Patent Application Publication
(10) Pub. No.: US 2020/0092648 A1
(43) Pub. Date: Mar. 19, 2020

(54) SYSTEM

(71) Applicant: Onkyo Corporation, Osaka (JP)

(72) Inventor: Tomoki KITAZAKI, Tokyo (JP)

(21) Appl. No.: 16/529,338

(22) Filed: Aug. 1, 2019

(30) Foreign Application Priority Data
Sep. 14, 2018 (JP) 2018-172027

(51) Int. Cl. H04R 3/12; G06F 16/61; H04R 5/04

(52) U.S. Cl. CPC H04R 3/12; H04R 5/04; G06F 16/61

(57) ABSTRACT

A system searching a predetermined content from multiple services.

### CROSS-REFERENCE TO RELATED APPLICATIONS

This application claims priority to Japanese Application No. 2018-172027, filed Sep. 14, 2018, the entire contents of which are incorporated herein by reference.

### FIELD

The present disclosure relates to a system which can use multiple services.

### BACKGROUND

There is a system which can use multiple music reproduction services. For example, the system can use multiple music reproduction services such as a music service (music service A) which is provided by an A company, a music service (music service B) which is provided by a B company and so on. Further, for example, there is a case where the system is composed of multiple speaker devices and the system is a system which performs multiple room reproduction which can reproduce the same music by the multiple speaker devices (for example, see JP 2017-216704 A.). An account is registered to each of the multiple speaker devices, and a speaker device can use the music service A, for example. Further, for example, another speaker device can use the music service B. There is a case where songs which can be provided by the music service A and the music service B are different for a user.

When a master which outputs music to the other speaker devices is fixed to a speaker which can use the music service A, for example, a user can only use songs (contents) which can be provided by the music service A. There is a problem that the user cannot use songs which cannot be provided by the music service A and can be provided by the music service B.

### SUMMARY OF THE DISCLOSURE

According to one aspect of the disclosure, there is provided a system searching a predetermined content from multiple services.

### BRIEF DESCRIPTION OF THE DRAWINGS

FIG. 1 is a block diagram illustrating a configuration of a multiple speaker system according to an embodiment of the present disclosure.

### DETAILED DESCRIPTION OF THE PREFERRED EMBODIMENTS

An objective of the present disclosure is to be able to provide various contents in a system which can use multiple services.

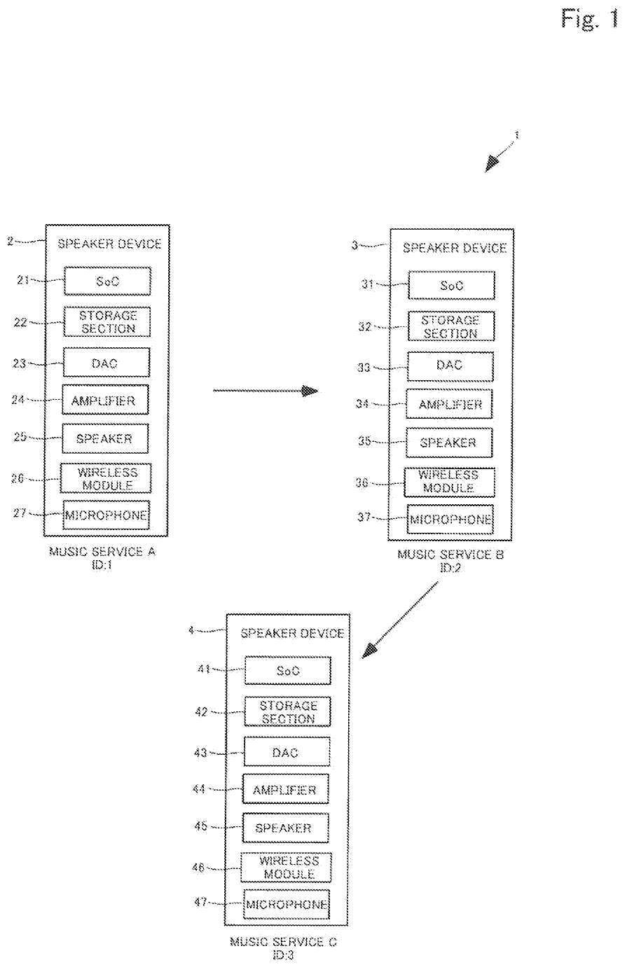

An embodiment of the present disclosure will be described below. FIG. 1 is a block diagram illustrating a multiple speaker system 1 according to the present embodiment. As illustrated in FIG. 1, the multiple speaker system 1 includes multiple speaker devices 2 to 4. In the present embodiment, a configuration of the speaker device 2 is described since the speaker devices 2 to 4 are the same configuration. Further, the multiple speaker system 1 may be composed of different speaker devices. Further, each of the speaker devices 2 to 4 is set in a different room such as a bed room, a dining room, a kitchen or the like.

The speaker device 2 (electronic device) includes an SoC (System on Chip) 21, a storage section 22, a D/A converter (hereinafter referred as to “DAC”) 23, an amplifier 24, a speaker 25, a wireless module 26, and a microphone 27. The SoC 21 (controller) has a CPU (Central Processing Unit), a DSP (Digital Signal Processor), a memory and so on, and controls each section composing the speaker device 2. The storage section 22 is composed of a flash memory which stores an application or the like for accessing music service. The DAC 23 D/A-converts digital audio data into analog audio data. The amplifier 24 amplifies the analog audio data which is D/A-converted by the DAC 23. The speaker 25 outputs audio based on the analog audio data which is amplified by the amplifier 24.

The wireless module 26 is for performing wireless communication according to Bluetooth (registered trademark) standard and Wi-Fi standard. The SoC 21 receives the digital audio data from a server which distributes songs or the other speaker devices 3 and 4 via the wireless module 26. The microphone 27 collects audio. The SoC 21 sends audio which is collected by the microphone 27 to the server via the wireless module 26. The server has voice recognition function and returns a command and the like based on audio which is received to the speaker device 2. The SoC 21 receives the command and the like which is sent by the server via the wireless module 26. For example, a user speaks “Play Song A.”. In this case, for example, a command “Play” which means playing and text “Song A” are sent to the speaker device 2 from the server.

In the multiple speaker system 1, any of the speaker devices becomes a master which outputs songs to the other speaker devices. The speaker device which became the master receives songs (digital audio data) from the server which provides music service. The speaker device which became the master reproduces songs which are received from the server. Further, the speaker device which became the master outputs songs to the other speaker devices. Further, speaker devices other than the master receive the songs which are output from the master. The speaker devices other than the master reproduce the received songs.

The speaker device 2 can use the music service A. An application which is for accessing the music service A is installed into the speaker device 2. The speaker device 3 can use the music service B. An application which is for accessing the music service B is installed into the speaker device 3. The speaker device 4 can use the music service C. An application which is for accessing the music service C is installed into the speaker device 4.

The speaker devices 2 to 4 exist within the same network. For example, when the speaker devices 2 to 4 are detected within the same network, IDs for identification (identification number) are assigned to the speaker devices 2 to 4. Further, for example, the IDs are set in order which is detected within the network. For example, when the speakers 2, 3 and 4 are detected within network in this order, “1” is assigned to the speaker device 2 as ID, “2” is assigned to the speaker device 3 as ID, and “3” is assigned to the speaker device 4 as ID. “ID: 1” is initial value of the master.

Herein, the speaker device 2 which connects to the network first becomes a temporary master. The SoC 21 of the speaker device 2 assigns “ID: 1” to the speaker device 2, assigns “ID: 2” to the speaker device 3, and assigns “ID: 3” to the speaker device 4. Further, each of the SoCs 21 to 41 notifies the assigned IDs and available music service to the speaker devices other than the speaker device itself. Thus, each of the SoCs 21 to 41 of the speaker devices 2 to 4 can store ID and music service in association with each other.

For example, a user speaks “Play Song A.”. In this case, the SoC 21 of the speaker device 2 searches “Song A” based on “Song A” which is sent from the server in the music service A. If the song A exists in the music service A, the SoC 21 reproduces the song A and sends the song A to the speaker devices 3 to 4. Therefore, the speaker device 2 becomes the master, and each of the speaker devices 3 and 4 becomes a slave. Namely, the speaker device 2 into which the application which is for accessing the music service A which can provide predetermined songs is installed becomes the master. If the song A does not exist in the music service A, the SoC 21 sends a song search demand to the speaker device 3 to which next identification number 2 is assigned.

When the SoC 31 of the speaker device 3 receives the song search demand of the song A, the SoC 31 becomes the temporary master and searches the song A in the music service B. If the song A exists in the music service B, the SoC 31 reproduces the song A and sends the song A to the speaker devices 2 and 4. Therefore, the speaker device 3 becomes the master, and each of the speaker devices 2 and 4 becomes the slave. If the song A does not exist in the music service B, the SoC 31 sends the song search demand to the speaker device 4 to which next identification number 3 is assigned.

When the SoC 41 of the speaker device 4 receives the song search demand of the song A, the SoC 41 becomes the temporary master and searches the song A in the music service C. If the song A exists in the music service C, the SoC 41 reproduces the song A and sends the song A to the speaker devices 2 and 3. Therefore, the speaker device 4 becomes the master, and each of the speaker devices 2 and 3 becomes the slave.

As described above, in the present embodiment, the multiple speaker system 1 searches a predetermined song (content) from multiple music services. Thus, various contents can be provided to a user since the predetermined content is searched from multiple music services.

The embodiment of the present disclosure is described above, but the mode to which the present disclosure is applicable is not limited to the above embodiment and can be suitably varied without departing from the scope of the present disclosure.

In the above described embodiment, the speaker device can use one music service. Not limited to this, the speaker device may use multiple music services. In this case, the SoC searches the song from the multiple music services.

In the above described embodiment, the song is searched from the music service. Not limited to this, content may be searched from a service, and movie or the like may be searched from movie distribution service or the like, for example.

In the above described embodiment, a case where multiple speaker devices compose a multiple speaker system is described. Not limited to this, if multiple services can be used, smart phones may compose a system, for example.

The present disclosure can be suitably employed in a system which can use multiple services.

What is claimed is:

1. A system searching a predetermined content from multiple services.

2. The system according to claim 1,
wherein an application which is for accessing the service is installed into the system.

3. The system according to claim 1, comprising:
an electronic device into which multiple applications which are respectively for accessing the multiple services are installed.

4. The system according to claim 1, comprising:
multiple electronic devices into which an application which is for accessing the service is installed.

5. The system according to claim 4,
wherein the multiple electronic devices include an electronic device which becomes a master which outputs the content to the other electronic device, and
the electronic device into which an application which is for accessing a service which can provide the predetermined content becomes the master.

6. The system according to claim 1,
wherein when the system searches the predetermined content from the multiple services and the predetermined content exists, the system reproduces the content.

7. The system according to claim 5,
wherein any electronic device of the multiple electronic devices becomes a temporary master, and
the electronic device which became the temporary master assigns identification numbers to the electronic device itself and the other electronic device.

8. The system according to claim 7,
wherein when the electronic device which became the temporary master searches the predetermined content and the predetermined content does not exist, the electronic device which became the temporary master sends a content search demand to the electronic device to which next identification number is assigned.

9. The system according to claim 8,
wherein when the electronic device which became the temporary master searches the predetermined content from the multiple services and the predetermined content exists, the electronic device which became the temporary master becomes the master.

10. The system according to claim 8,
wherein when the electronic device receives the content search demand, the electronic device becomes the temporary master.
